(19) United States
(12) Patent Application Publication
(10) Pub. No.: US 2015/0169287 A1
(43) Pub. Date: Jun. 18, 2015

(54) ARTIFICIAL INTELLIGENCE USER INPUT SYSTEMS AND METHODS

(71) Applicant: Michael Ghandour, Chino, CA (US)

(72) Inventor: Michael Ghandour, Chino, CA (US)

(21) Appl. No.: 14/574,349

(22) Filed: Dec. 17, 2014

Related U.S. Application Data
(60) Provisional application No. 61/917,315, filed on Dec. 17, 2013.

(51) Int. Cl. G06F 3/16; G10L 15/22; G10L 15/26

(52) U.S. Cl. CPC G06F 3/167; G10L 15/265; G10L 15/22; G10L 2015/223

(57) ABSTRACT

A system and method for interaction with a computer device that includes receiving, by a computer device, input from a user, determining based on the context of the input whether to perform an action by the computer device and performing an action by the computer device based on further detecting the confidence input received form the user.

### PRIORITY CLAIM AND CROSS-REFERENCE TO RELATED APPLICATIONS

This application claims the benefit of U.S. Provisional Application No. 61/917,315, filed Dec. 17, 2013, which is incorporated herein by reference in its entirety.

### FIELD

The embodiments disclosed below relate generally to the field of interactions of humans with computing devices. More specifically, the embodiments relate to systems and methods for enabling individuals to interact with their electronic devices using voice, gesture, or visual input.

### BACKGROUND

Users have a plurality of devices that are used to provide a user interface like keyboard, mouse or touch input. When users communicate with other users, it is easier for them to do so verbally. Verbal input has evolved but has yet to become a proficient method of communicating between humans and computers. Further improvements in verbal user interface between humans and computers are described herein.

### SUMMARY

One embodiment relates to a computer-implemented method or system that Receives input from a user, determines based on the context of the input whether to perform an action by the computer device and performing an action by the computer device based on further detecting the confidence input received form the user. The system or method may receive continuous audio input from the user. The system or method may be configured to receive and process the audio input continuously. The method or system may determine the confidence of the user by analyzing how loud the user is at the end of the word. The input may be in the form of an audio signal. The computer device is configured to receive the audio input continuously. In the method, the context further comprises determining a confidence level of the user by analyzing how loud the user is at the end of the word. The method of claim 1, wherein the computer device is configured receive the audio input without requiring the user input from a keyboard, mouse or touch interface. The received audio input may be transcribed into text and the text sent to a server computer to be separated and searched by a plurality of search computer engines.

A computer system having a processing that is configured to receive text from one or more user computers, separate the text into small portions, send each of the small portions of text to a different search computer system, receive a search result list of from each of the search computer system and rank each of the search results by correlating search results from the different search computer systems. The processor may be configured to send the searches to different search computer systems that are each owned by a different entity. The different search computer system may use a different search algorithm computer to another search computer system. The different computer systems may be selected because they use different search algorithm. The computer system may rank based on the text. The computer system may rank based on the small portions of text.

A computer device with a processor coupled to a non-transitory storage medium, the processor configured to receive, by a computer device, input from a user, determine based on the context of the input whether to perform an action by the computer device, and perform an action by the computer device based on further detecting the confidence input received form the user. The computer device may receive the input is in the form of an audio signal. The computer device may be configured to convert the audio signal into text that is split into a plurality of text strings to be searched by more than one different search computer system.

### BRIEF DESCRIPTION OF THE DRAWINGS

FIG. 1 is a screen shot prompting the user to provide authentication credentials.

FIG. 2 is a screen shot showing a display that may be generated based on the voice output and input by a computer device.

FIG. 3 shows a various features that may be provided by different plans.

FIG. 4 is a flow diagram showing the user input being processed by a system.

FIG. 5 is a flow diagram showing the user input being processed by a system in another embodiment.

FIG. 6 is a system diagram of a computer system.

FIG. 7a is a system diagram of a computer system according to an embodiment.

FIG. 7b is a screen shot showing a display that may be generated by the embodiments described herein.

FIG. 8 is a screen shot showing a display that may be generated by the embodiments described herein.

FIG. 9 is a screen shot showing a display that may be generated by the embodiments described herein.

FIG. 10 is a screen shot showing a display that may be generated by the embodiments described herein.

FIG. 11 is a screen shot showing a display that may be generated by the embodiments described herein.

FIG. 12 is a screen shot showing a display that may be generated by the embodiments described herein.

### DETAILED DESCRIPTION

Embodiments may be implemented on computing devices such as but not limited to, a mobile phone, tablet computer, laptop computer, desktop computer, remote access computer, etc. Embodiments include a multifunctional software implemented on a hardware device (non-transitory computer storage media) that employs advanced user interface such as gestures, iris and voice input, to perform actions and interact with users.

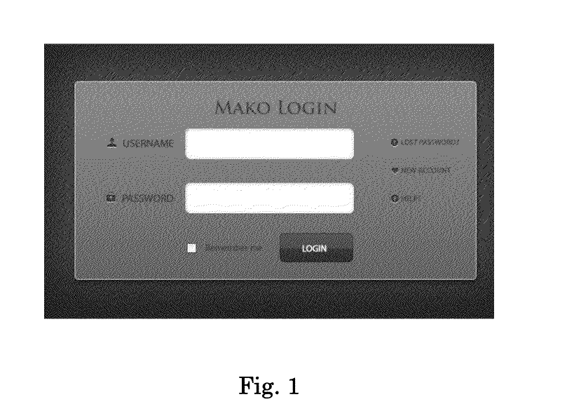

FIG. 1 is a screen shot prompting the user to provide authentication credentials. The screen in FIG. 1 requests a username and a password is provided by the user. The screen in FIG. 1 allows a user to choose to setup a new account or look up a forgotten password.

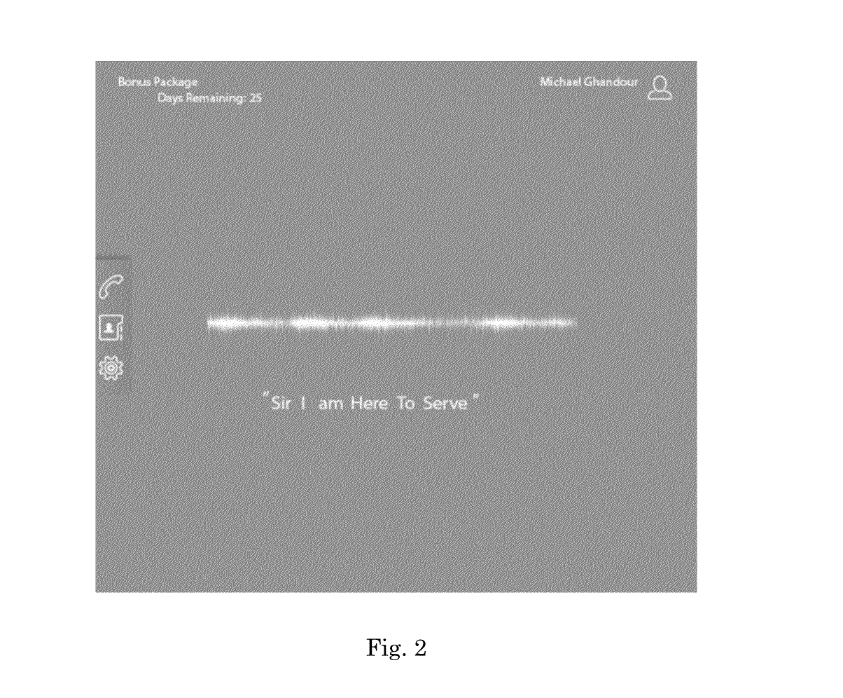

FIG. 2 is a screen shot showing a display that may be generated based on the voice output and input to or from a computer device. In one embodiment, the system can assist anyone on a computing device to accomplish basic or complex tasks much faster and interact with a system as if it were an individual being assigned to do some tasks. The systems and method described herein can also be used to benefit the disabled/handicapped by reading or typing text for the elderly or visually impaired. Various features may be executed by speaking clearly and asking the system to open programs, websites, type keys, or perform tasks a computer.

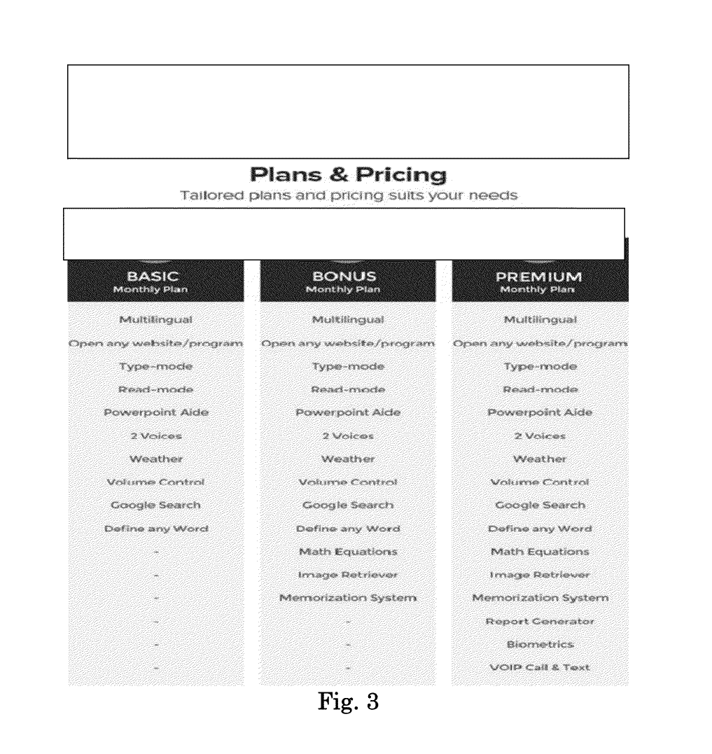

FIG. 3 shows a features that may be provided by a tiered plan. The use of the system will be to add more functionality to any computing device. The system will add an artificial intelligence assistant into the computing device. The assistants name may be verbally programmable by a user. The computing device may perform voice commands that are spoken by a user. The software may be distributed by digital downloads and the user may charged on a monthly basis. Here is a list of the packages that will be sold commercially.

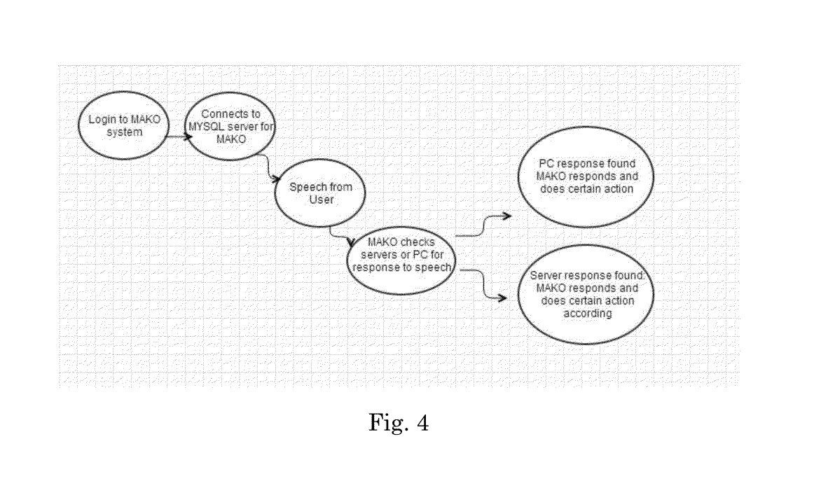

FIG. 4 is a flow diagram showing the user input being processed by a system. In the embodiments described herein, the computer is configured to continuously receive audio signals from the user and connect to one or more database servers for a fast response and action to be taken depending on audio command received from the user. In various embodiments, the computer system continuously records and processes the audio signal received from the user. Not only does the system use dictation as a form of speech recognition instead of traditional push-to-talk applications, but the computer includes a number of other features.

Embodiments are directed to artificial intelligence systems that are reliable and effective. Embodiments use voice recognition combined with algorithms, and a plurality of APIs and data sources to rank and generate the most relevant results. For example, the Wikipedia API in combination with the Facebook® API may be used to provide answers and using Facebook API and Skype API to communicate in a faster and more subtle way.

Other solutions can be inflexible with their commands and may require annoying and hassle push to talk method to speak basic commands. Embodiments do not require push to talk or push to listen. Embodiments are directed to systems that are always listening and only require a small amount of processing power for its capabilities. In some embodiments, the software may configure the computer to use only a fraction of the available cores available on the computer for processing the audio input. For example, the software may request that only 2 of the 4 processing cores on a processor are used for audio input processing. In other embodiments, the software may limit the number of processes or the size of the processes used to process audio input. In various embodiments, the system does not requires the user to push a key, press a mouse button, provide touch interface to the computer screen or do a gesture for the system to continuously be receiving audio input. The system uses the dictation function. In various embodiments, the system is configured to determine the confidence in the user's tone to determine whether a command is being spoken. In other embodiments, the system may enter command mode after the user provides audio input that represents the systems given name (also programmable by the user). The system has certain predetermined commands that it knows are commands. The system detects whether a user is talking to other people or whether the user is talking to the system. The system may determine that two different voices are talking by measuring the frequency of the received audio input. Listing in context can mean that the dictation software can determine whether the user is talking to the system or another individual. Alternatively, when the user generates an audio signal that uses the name of the system the dictation system knows to perform a command or perform an action. In various embodiments, the user may determine a name for the computer and the system will recognized itself as that name after the name has been programmed into the computer. Speaking in context may include that the system recognize everything that a user is saying.

The process or the system use many algorithms and methods that help determine if the user are speaking directly the system or towards another person, this is done by a method that checks what the user is saying and determines by listening in context if the user is talking to the system. The user is talking to the person, the pre-listed commands are executed by a speech recognition circuit or engine that uses dictation functionality to understand every word said by the user rather than looking through commands and confusing words with commands. The system also uses a confidence level method that checks if a user is in the process of speaking to a person (not directly to the system). The system does not initiate an action because of the confidence and speaking_in_progress( ) method.

The system may be configured to received audio signals that contain (“certain predetermined words”) the software searches to determine if the user said something in your speech or if the audio signal contains certain words than the system will process as a predetermined command. The system checks if the user is speaking in context with the methods recited above to determine to use the speech and initiate a command or just disregard the input. Various advantages of the system include the ability to disregard certain audio input from the user. The audio

The system uses an advanced user interface and complex login algorithm to make sure the product cannot be pirated or used without a registered account. The server system also uses advanced methods (programed in various languages such as but not limited to objective C, C++, C#, Java, etc.) that give the system a fast response time when looking through online API or program API that is currently linked to the system. The system also provides an economic advantage for the users. Users can receive an artificial intelligence program smart enough to read anything they want, type anything, and many other features.

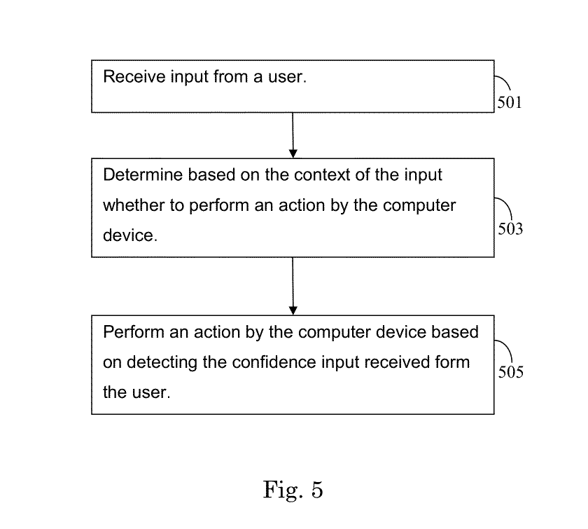

FIG. 5 is a flow diagram showing the user input being processed by a system in various embodiments. At step 501, the system may receive user input in the form of audio signal received by a microphone. In other embodiments, the input may be received via a camera as an image or a gesture. In other embodiments, the system may be configured to process input from both the camera and the microphone. Next, at step 503, the system may determine based on the context of the user input (e.g. speech) whether to perform an action by the computer device. Next, at step 505, the system performs an action based on detecting the confidence of the input received from the user.

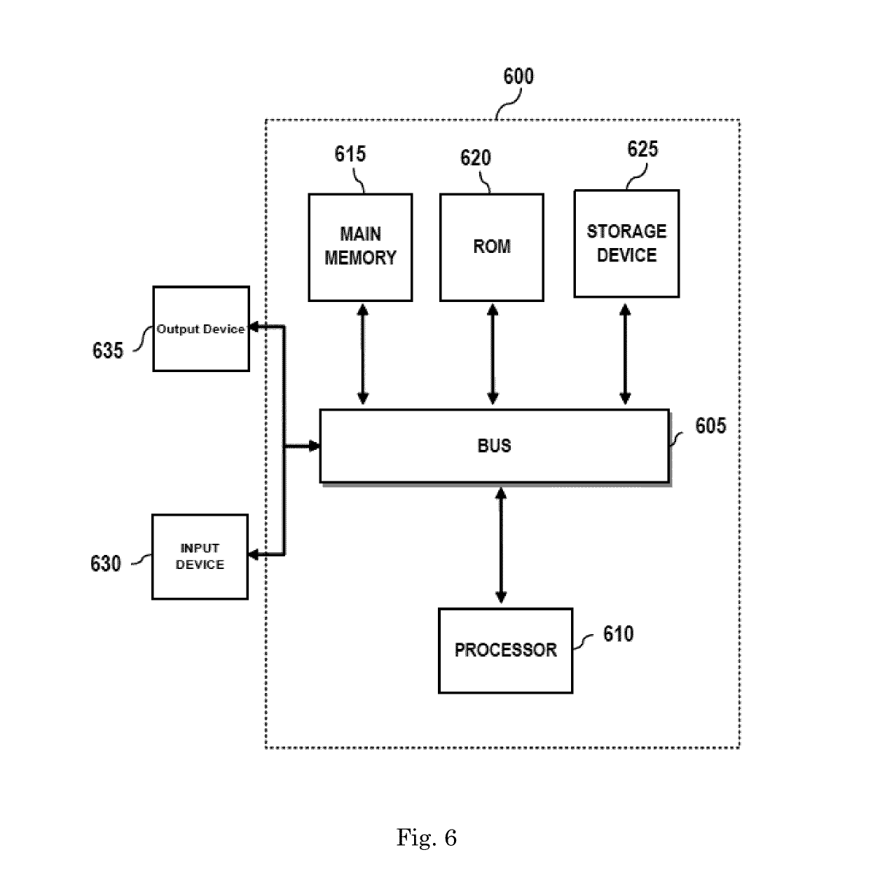

FIG. 6 illustrates a depiction of a computer system 600 that can be used to provide user interaction reports, process log files, receive user input audio or gesture and process the input. The computing system 600 includes a bus 605 or other communication mechanism for communicating information and a processor 610 coupled to the bus 605 for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid-state device, non-transitory storage media, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another embodiment, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various embodiments, the processes that effectuate illustrative embodiments that are described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative embodiments, hard-wired circuitry may be used in place of or in combination with software instructions to implement illustrative embodiments. Thus, embodiments are not limited to any specific combination of hardware circuitry and software.

The embodiments described herein may be used to implement various features. For example features such as, but not limited to text read mode, research center, custom speech command acceptance, self-aware mode, and custom user interface.

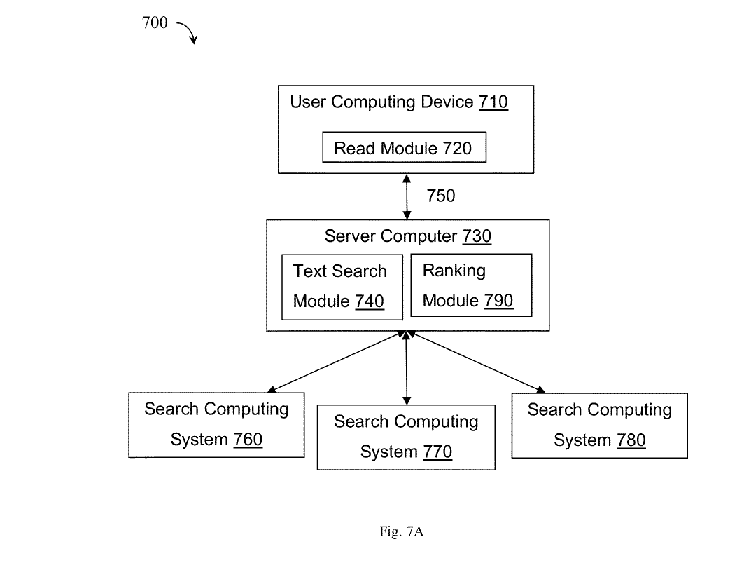

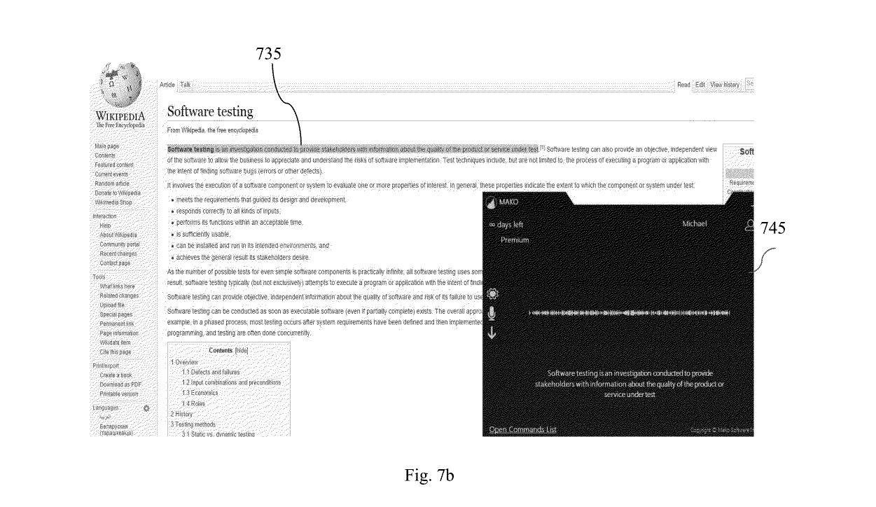

FIG. 7a illustrates a system 700 that includes among other systems a user computing device 710, a server computer 730, and a plurality of search computing systems 750, 760, and 770. The embodiments of the devices, computers, and computing systems include at least the components shown in FIG. 6. Moreover, embodiments of the devices, computers, and computing systems may include specialized components, systems or software to perform the operations mentioned herein. Embodiments of the devices may include additional modules, implemented in a special purpose computer.

The user computer 710 may be a computer system that is a user device, such as but not limited to, a desktop computer, a laptop computer, a tablet computer, a phablet, a mobile device, a cellular telephone, a landline connected phone, etc. The user computer 710 includes among other hardware a read module 720. In various embodiments, the user computer 710 may be configured to receive continuous audio input from a user and determine that a “read mode” command has been executed. Responsive to determining that the user computer 710 has received an audio command to be in “read mode”, the user computer 710 will begin to speak any text that is highlighted. In some embodiments, the user may provide audio input to the highlight the text to be read, such as, but not limited to, highlight the first sentence of a paragraph, as shown in FIG. 7b. After highlighting the text 735, the user computer 710 is configured to generate an audio signal that reads the text via the computer system. In some embodiments, once the user computer 710 is placed in “read mode”, the user computer 710 may copy all of the text that is displayed on the user's computer display. The copied text may be sent to a read module 720 that may be configured to divide the text into a plurality of portions of the original text. Next, each of the portions may be sent via a network 750 to a server 730. The server 730 may include a text search component 740 and a ranking component 790.

In various embodiments, after receiving the audio signal the audio signal may be translated into text and the text may be divided into portions to be searched individually. In some embodiments, the text search component 740 may be configured to send portions of the text via a network to search computer system 760, search computer system 770 and search computer system 780. The search computer systems 760, 770 and 780 may generate search results for the portion of the text that was received by them and communicate the search results back to the server computer 730. After receiving the plurality of search results the server computer 730 may use the ranking module 790. The ranking module 790 may compare the search results for each portion of the originally generated text and determine which one of the search results matches in subject matter and select one matched entry from each search computing system 760, 770 and 780 to be displayed or each matched entry is combined. In some embodiments, the server computer 730 may combine the entries to form a complete response back to the user computer 710. The user compute 710 may generate an audio signal back to the user in response to the originally generated audio input that was received from the user.

FIG. 7b illustrates an image of an example webpage 701 that may be displayed on a user computer 710 (shown in greater detail in FIG. 7b). Read mode is a speech command on the user computer 710. When the user initiates the command the software receives the highlighted text that the user highlighted. The user computer 710 receives the information by copying the text onto a temporary location such as but not limited to a clipboard. In other embodiments, the text may be saved and sent to the server computer 730 and may be used for other inquires by the same user in the future and the text may be associated with the user's profile. After the computer 710 determines the audio signal to generate the computer may display 745.

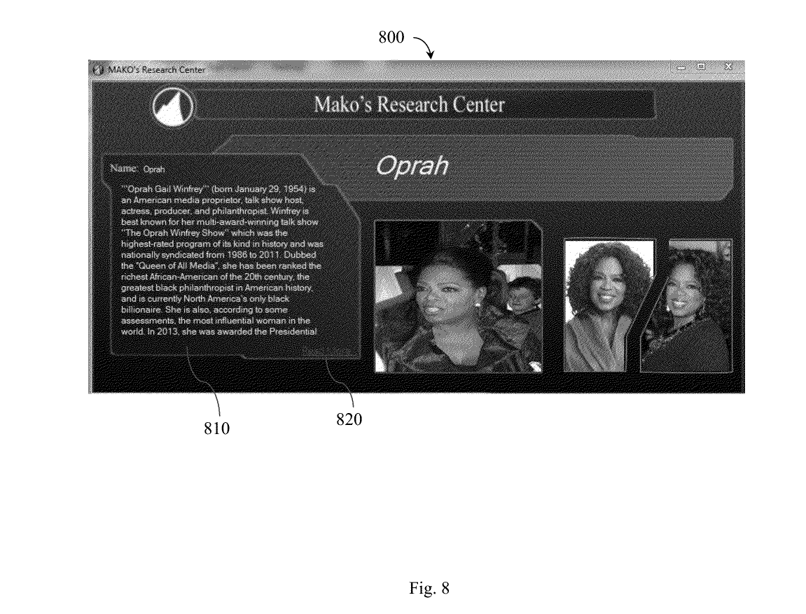

FIG. 8 illustrates an a research center screen 800. The system is configured to provide the user with information regarding any known subject. The computer system performs this by utilizing fast HTTP connections. Once the user initiates the research center, the research center performs a query through one or more search engines (as described above) silently and quickly searching for the Wikipedia page or any reputable website with information on the user defined subject. When the software receives or locates at least 3 images, the images may be inserted into the research center. The information that is received from the search is also inserted in a box 810 where information is stored. The end result that the user sees after giving the speech command is shown in FIG. 8. Typically the computer system can execute and gather results within a few second (e.g., 1 to 5 seconds), depending on the user's Internet speed. The display includes a read more button 820. If the user clicks the Read more button 820, the computer displays a link to the information that was gathered. In some embodiments, the computer system requests that the computer may generate an audio signal to read the gathered information.

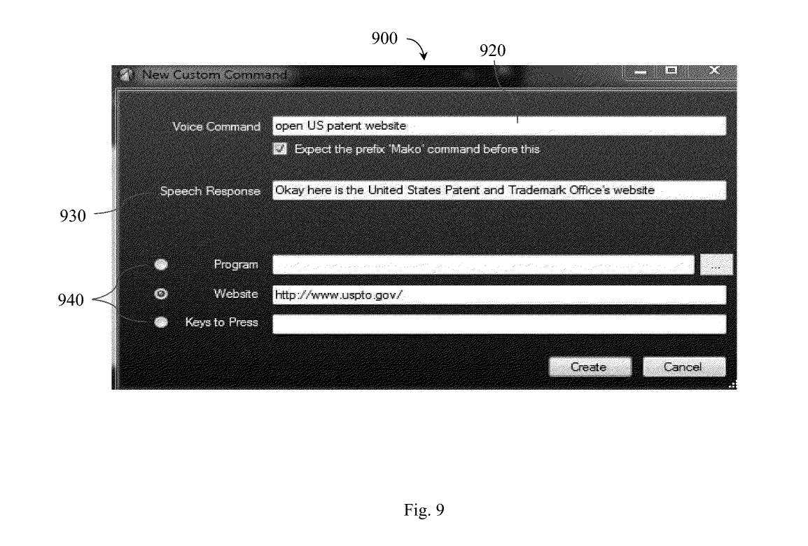

FIG. 9 illustrates the custom speech command display 900. The system maybe preloaded with a list of default speech commands. In some embodiments, the computer may not provide a user the permissions to alter the pre-programmed commands. In other embodiments, the computer system may permit the user to create custom speech commands. The custom speech commands may be used for various actions for example but not limited to opening programs, websites, or pressing keys as shown by radio buttons 940. As shown in the command display 900, the user inserts a command 920 open patent website, the user then types in the speech response 930 the system should respond with. Lastly the user chooses whether the command should execute a program or website or press one or more keys for the user. These features provide various possibilities to mix and match commands that are not available by using the default commands. The computer is configured to execute the command by taking the variables the user inserts into the software's command interface and then using a series of (else If) code the software creates the command for the user and saves it in a folder (e.g., the install folder) for further use. The command interface is shown in FIG. 9.

Other embodiments of the computer may include a self-aware mode as a default command. When the user initiates the speech command the computer may initiate a connection request via HTTPS to the server computer if the connection is successful the computer connects to the online server. Once the user is connected, the user can ask the computer any question, or say anything to it and the server (as mentioned above) generates the appropriate response. The appropriate response that the user computer receives from the server is a response that is generated via an artificial intelligence algorithm of the server computer to have conversations with humans. The server computer uses admins (individuals) that are logged in to the servers via their computers to get a response, if no admin is online to respond to the query, the server will determine what the user is saying by checking the key words in the speech query. The computer system also uses past information about the user, which is stored on an SQL server. For example, if a user tells a computer in self-aware mode his birthday is on the 15th of April then asks the computer when his birthday, the computer is configured to be able to use the “chat logs” on the server (e.g., Oracle, SQL, etc.) to respond with the correct response. The server computer may be online for a few hours for admins to be able to monitor the server's responses and to supervise all responses and work on advancing its artificial brain. The server may store megabytes or terabytes (e.g., 60 megabytes approximately 30,000 pages) of textchat logs per user.

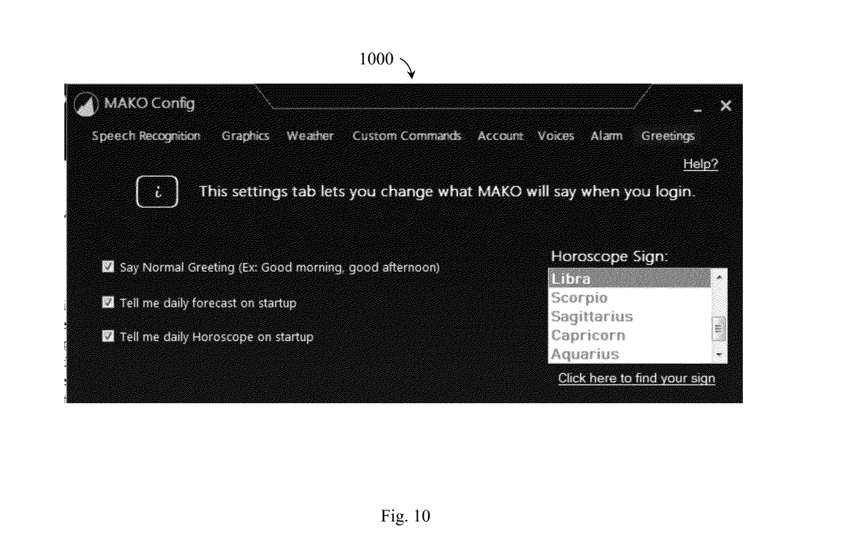

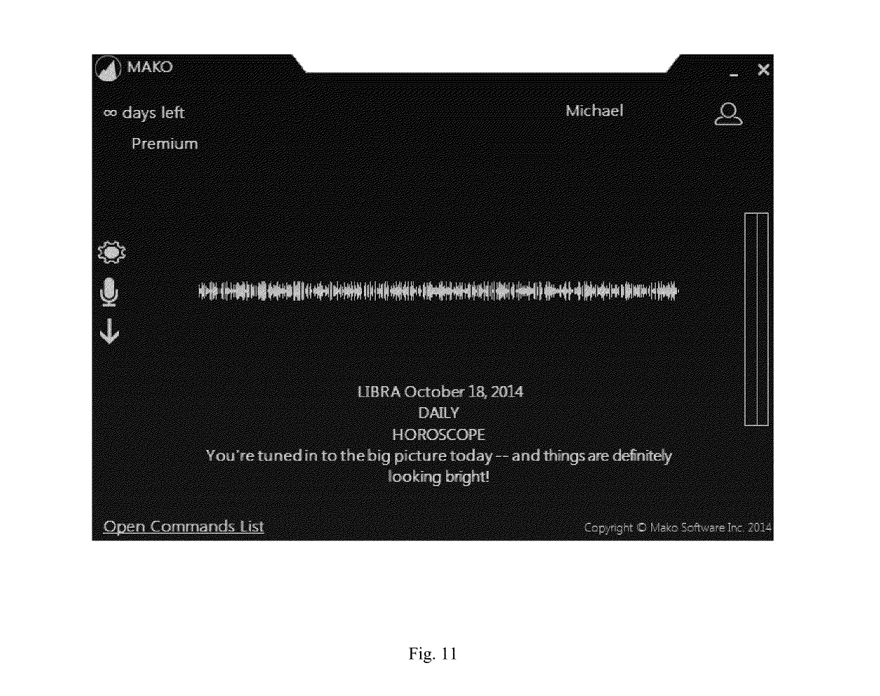

The computer system may be configured to generate FIG. 10 with the daily horoscope display 1000 features. The daily horoscope function allows users to hear their daily horoscope report from one or more Astrology websites, chosen by the user. The horoscope feature works by initiating a check on the current date by using one or more programming languages. After determining the current date, the computer searches to determine the user's zodiac sign, which the user may define in the settings option. In some embodiments, the query is sent to an open source astrology website and the computer receives a response with the report according to the zodiac sign. The report is text that may be read by the computer system as shown in FIG. 11.

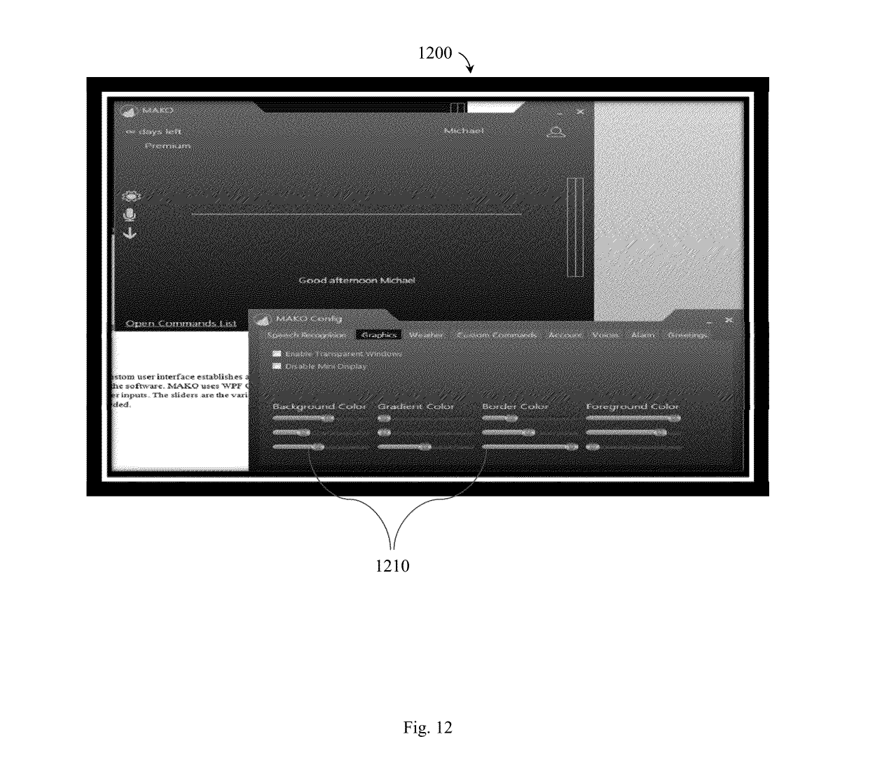

In other embodiments, the computer provides a custom user interface 1200 as shown in FIG. 12. The custom user interface has a design where the user controls the look and feel of the display. The computer interface may use WPF GDI+ functionality to change the interface to any color the user chooses. The sliders 1210 provide data input to variables, that the computer checks to provide the color and contrast as needed.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. The present embodiments contemplate methods, systems and program products on any machine-readable media for accomplishing its operations. The embodiments of may be implemented using an existing computer processor, or by a special purpose computer processor incorporated for this or another purpose or by a hardwired system.

As noted above, embodiments within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A computer-implemented method, comprising:
receiving, by a computer device, input from a user;
determining based on the context of the input whether to perform an action by the computer device; and
performing an action by the computer device based on further detecting the confidence input received form the user.

2. The method of claim 1, wherein the input is in the form of an audio signal.

3. The method of claim 1, wherein the computer device is configured receive the audio input continuously.

4. The method of claim 1, wherein the context further comprises determining a confidence level of the user by analyzing how loud the user is at the end of the word.

5. The method of claim 1, wherein the computer device is configured receive the audio input without requiring the user input from a keyboard, mouse or touch interface.

6. The method of claim 1, wherein the received audio input is transcribed into text and the text sent to a server computer to be separated and searched by a plurality of search computer engines.

7. A computer system, comprising a memory that is configured to:
receive text from one or more user computers;
separate the text into small portions;
send each of the small portions of text to a different search computer system;
receive a search result list of from each of the search computer system; and
rank each of the search results by correlating search results from the different search computer systems.

8. The computer system of claim 7, wherein each of the different search computer system is owned by a different entity.

9. The computer system of claim 8, wherein the different search computer system uses a different search algorithm computer to another search computer system.

10. The computer system of claim 9, wherein the ranking is performed based on the text.

11. The computer system of claim 9, wherein the ranking is performed based on the small portions of text.

12. A computer device, comprising:
a processor coupled to a non-transitory storage medium, the processor configured to:
receive, by a computer device, input from a user;
determine based on the context of the input whether to perform an action by the computer device; and
perform an action by the computer device based on further detecting the confidence input received form the user.

13. The computer device of claim 12, wherein the input is in the form of an audio signal.

14. The computer device of claim 13, further comprising the processor configured to convert the audio signal into text that is split into a plurality of text strings to be searched by more than one different search computer system.
